(19) United States
(12) Patent Application Publication
(10) Pub. No.: US 2015/0206346 A1
(43) Pub. Date: Jul. 23, 2015

(54) METHOD AND APPARATUS FOR REPRODUCING MEDICAL IMAGE, AND COMPUTER-READABLE RECORDING MEDIUM

(71) Applicant: SAMSUNG ELECTRONICS CO., LTD., Suwon-si (KR)

(72) Inventor: Keum-yong OH, Suwon-si (KR)

(73) Assignee: SAMSUNG ELECTRONICS CO., LTD., Suwon-si (KR)

(21) Appl. No.: 14/600,446

(22) Filed: Jan. 20, 2015

(30) Foreign Application Priority Data
Jan. 20, 2014 (KR) 10-2014-0006737

(51) Int. Cl. G06T 19/00; G06F 17/24; G06T 7/00

(52) U.S. Cl. CPC G06T 19/003; G06T 7/0012; G06F 17/241; G06T 2219/004

(57) ABSTRACT

Provided is a medical image reproducing method. The medical image reproducing method includes reproducing a three-dimensional (3D) medical image which includes a two-dimensional (2D) left-eye image and a 2D right-eye image, determining a 3D effect of an annotation based on an offset value which relates to an offset between the left-eye image and the right-eye image in order to insert the annotation into the 3D medical image, and displaying the annotated 3D medical image.

### RELATED APPLICATION

This application claims priority from Korean Patent Application No. 10-2014-0006737, filed on Jan. 20, 2014, in the Korean Intellectual Property Office, the disclosure of which is incorporated herein by reference in its entirety.

### BACKGROUND

1. Field

One or more exemplary embodiments relate to a method and apparatus for reproducing a medical image, and a computer-readable recording medium storing computer program codes for executing the medical image reproducing method.

2. Description of the Related Art

In a medical image photographing system, a photographing technique and an image processing technique for expressing a three-dimensional (3D) medical image have been recently researched. A 3D medical image three-dimensionally expresses a structure of an object, and thus expresses the structure of the object to a user so as to be similar to an actual image. A 3D medical image may be captured by, for example, any one or more of a magnetic resonance imaging (MRI) system, a computed tomography (CT) system, an X-ray system, and an ultrasound system.

In a 3D medical image, subjects having various focal distances are included in one image, and for this reason, a user that views the 3D medical image may suffer from eye fatigue.

### SUMMARY

One or more exemplary embodiments include a method and apparatus for reproducing a medical image, which decrease a user's eye fatigue when providing an annotation in a 3D medical image.

One or more exemplary embodiments include a method and apparatus for reproducing a medical image, which three-dimensionally provide an annotation and additional information in a 3D medical image.

Additional aspects will be set forth in part in the description which follows and, in part, will be apparent from the description, or may be learned by practice of the exemplary embodiments.

According to one or more exemplary embodiments, a medical image reproducing method includes: reproducing a three-dimensional (3D) medical image which includes a left-eye image (image for left eye) and a right-eye image (image for right eye); determining a 3D effect of an annotation based on an offset value which relates to an offset between the left-eye image and the right-eye image; inserting the annotation into the 3D medical image; and displaying the annotated 3D medical image.

The inserting the annotation may include: determining a position of the annotation; shifting the determined position of the annotation by the offset value in a first direction in order to insert the shifted annotation into the right-eye image; and shifting the determined position of the annotation by the offset value in a second direction in order to insert the shifted annotation into the left-eye image, the second direction being opposite to the first direction.

The offset value may be stored in conjunction with the 3D medical image.

The 3D medical image may include a plurality of 3D series images which are associated with different respective offset values, and the reproducing the 3D medical image may include reproducing at least one of the plurality of 3D series images.

The medical image reproducing method may further include determining a 3D effect of additional information based on an offset value which relates to the reproduced at least one 3D series image in order to insert the additional information into the reproduced at least one 3D series image.

The inserting the additional information may include: determining a position of the additional information; shifting the determined position of the additional information by the offset value which relates to the reproduced at least one 3D series image in a first direction in order to insert the shifted additional information into a right-eye image of the reproduced at least one 3D series image; and shifting the determined position of the additional information by the offset value which relates to the reproduced at least one 3D series image in a second direction in order to insert the shifted additional information into a left-eye image of the reproduced at least one 3D series image, the second direction being opposite to the first direction.

The medical image reproducing method may further include, when a first reproduced 3D series image is changed while reproducing the 3D medical image, reflecting an offset value which relates to the first reproduced 3D series image in order to insert the additional information into the first reproduced 3D series image.

The inserting the annotation may include inserting an annotation, which is associated with the reproduced at least one 3D series image, into the reproduced at least one 3D series image based on an offset value which relates to the reproduced 3D series image.

The inserting the annotation may include, when a first object included in the 3D medical image is selected while reproducing the 3D medical image, inserting an annotation which is associated with the first object into the 3D medical image based on an offset value which corresponds to the first object.

According to one or more exemplary embodiments, a medical image reproducing apparatus includes: a reproduction device configured to reproduce a three-dimensional (3D) medical image which includes a left-eye image and a right-eye image; an annotation inserter configured to determine a 3D effect of an annotation based on an offset value which relates to an offset between the left-eye image and the right-eye image, and to insert the annotation into the 3D medical image; and a display device configured to display the annotated 3D medical image.

The annotation inserter may include: an annotation position determiner configured to determine a position of the annotation; and an annotation synthesizer configured to shift the determined position of the annotation by the offset value in a first direction in order to insert the shifted annotation into the right-eye image, and to shift the determined position of the annotation by the offset value in a second direction in order to insert the shifted annotation into the left-eye image, the second direction being opposite to the first direction.

The offset value may be stored with the 3D medical image.

The 3D medical image may include a plurality of 3D series images which are associated with different respective offset values, and the reproduction device may be further configured to reproduce the 3D medical image by reproducing at least one of the plurality of 3D series images.

The medical image reproducing apparatus may further include an additional information inserter configured to determine a 3D effect of additional information based on an offset value which relates to the reproduced at least one 3D series image, and to insert the additional information into the reproduced at least one 3D series image.

The additional information inserter may include: an additional information position determiner configured to determine a position of the additional information; and an additional information synthesizer configured to shift the determined position of the additional information by the offset value which relates to the reproduced at least one 3D series image in a first direction in order to insert the shifted additional information into a right-eye image of the reproduced at least one 3D series image, and to shift the determined position of the additional information by the offset value which relates to the reproduced at least one 3D series image in a second direction in order to insert the shifted additional information into a left-eye image of the reproduced at least one 3D series image, the second direction being opposite to the first direction.

When a first reproduced 3D series image is changed while reproducing the 3D medical image, the additional information inserter may be further configured to reflect an offset value which relates to the first reproduced 3D series image in order to insert the additional information into the first reproduced 3D series image.

The annotation inserter may be further configured to insert an annotation, which is associated with the reproduced at least one 3D series image, into the reproduced at least one 3D series image based on an offset value which relates to the reproduced at least one 3D series image.

When a first object included in the 3D medical image is selected while reproducing the 3D medical image, the annotation inserter may be further configured to insert an annotation associated with the first object into the 3D medical image based on an offset value which corresponds to the first object.

According to one or more exemplary embodiments, provided is a non-transitory computer-readable storage medium storing a program which, when read and executed by a computer, performs a medical image reproducing method including: reproducing a three-dimensional (3D) medical image which includes a left-eye image and a right-eye image; determining a 3D effect of an annotation based on an offset value which relates to an offset between the left-eye image and the right-eye image; inserting the annotation into the 3D medical image; and displaying the annotated 3D medical image.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a schematic diagram of an MRI system;

FIG. 2 is a diagram which illustrates an operation of capturing a medical image in a two-dimensional (2D) photographing mode, according to an exemplary embodiment;

FIG. 3 is a diagram which illustrates an operation of capturing a medical image in a 3D photographing mode, according to an exemplary embodiment;

FIG. 4 is a diagram which illustrates a structure of a medical image, according to an exemplary embodiment;

FIG. 5 is a diagram illustrating an example of a user interface screen for capturing a medical image, according to an exemplary embodiment;

FIG. 6 is a diagram illustrating a structure of a 3D series image, according to an exemplary embodiment;

FIG. 7 is a diagram illustrating a configuration of a communication unit;

FIG. 8 is a diagram illustrating a structure of a medical image reproducing apparatus, according to an exemplary embodiment;

FIG. 9 is a diagram which illustrates an operation of inserting an annotation, according to an exemplary embodiment;

FIG. 10 is a diagram which illustrates an operation of inserting an annotation, according to an exemplary embodiment;

FIG. 11 is a diagram illustrating an example of a generated 3D medical image, according to an exemplary embodiment;

FIG. 12 is a diagram which illustrates an operation of inserting an annotation, according to an exemplary embodiment;

FIG. 13 is a diagram illustrating an example of reproducing a medical image in a 2D mode and a 3D mode, according to an exemplary embodiment;

FIG. 14 is a diagram illustrating an example of a reproduction unit and an annotation inserting unit of a medical image reproducing apparatus, according to an exemplary embodiment;

FIG. 15 is a diagram which illustrates an operation of expressing an offset, according to an exemplary embodiment;

FIG. 16 is a diagram which illustrates an operation of arranging an object and an annotation on focal planes, according to an exemplary embodiment;

FIG. 17 is a diagram which illustrates an operation of expressing an offset value, according to an exemplary embodiment;

FIG. 18 is a diagram which illustrates an operation of expressing an offset value, according to another exemplary embodiment;

FIG. 19 is a diagram which illustrates an operation of expressing a 3D annotation, according to an exemplary embodiment;

FIG. 20 is a flowchart of a 3D medical image reproducing method, according to an exemplary embodiment;

FIG. 21 is a diagram illustrating a structure of an annotation inserting unit, according to another exemplary embodiment;

FIG. 22 is a flowchart of an operation of inserting an annotation, according to an exemplary embodiment;

FIG. 23 is a diagram illustrating a structure of a medical image reproducing apparatus, according to another exemplary embodiment;

FIG. 24 is a diagram which illustrates a structure of a medical image with additional information inserted thereinto, according to an exemplary embodiment; and

FIG. 25 is a flowchart of a medical image reproducing method, according to another exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present disclosure. As used herein, the term “and/or” includes any and all combinations of one or more of the associated listed items. Expressions such as “at least one of,” when preceding a list of elements, modify the entire list of elements and do not modify the individual elements of the list.

One or more exemplary embodiments will now be described more fully with reference to the accompanying drawings. The present inventive concept may, however, be embodied in many different forms and should not be construed as being limited to the exemplary embodiments set forth herein; rather, these exemplary embodiments are provided so that this disclosure will be thorough and complete, and will fully convey the present inventive concept to those of ordinary skill in the art.

Terms used herein will now be briefly described and then one or more exemplary embodiments will be described in detail.

General terms widely used are selected while considering functions in one or more exemplary embodiments for terms used herein, but the terms used herein may differ according to intentions of one of ordinary skill in the art, precedents, or emergence of new technologies. Further, in some cases, an applicant arbitrarily selects a term, and in this case, the meaning of the term will be described in detail herein. Accordingly, the terms shall be defined based on the meanings and details throughout the specification, rather than the simple names of the terms.

When something “includes” a component, another component may be further included unless specified otherwise. The term “unit” as used in the present specification may refer to a software component, or a hardware component such as field-programmable gate array (FPGA) or an application-specific integrated circuit (ASIC), and is configured to perform a certain function. However, the “unit” is not limited to software or hardware. The “unit” may be configured in an addressable storage medium and may be configured to be executed by one or more processors. Hence, the “unit” may include any one or more of elements such as software elements, object-oriented software elements, class elements, and task elements, and processes, functions, attributes, procedures, sub-routines, segments of program codes, drivers, firmware, micro-codes, circuits, data, databases, data structures, tables, arrays, and variables. The functions provided in the elements and the units may be combined into a fewer number of elements and units or may be divided into a larger number of elements and units.

While describing one or more exemplary embodiments, descriptions about drawings that are not related to the one or more exemplary embodiments are omitted.

In the present specification, “image” may refer to multi-dimensional data composed of discrete image elements (e.g., pixels in a two-dimensional image and/or voxels in a three-dimensional image). For example, an image may include a medical image of an object that is acquired by an X-ray, computed tomography (CT), magnetic resonance imaging (MRI), ultrasonic waves, or another medical image photographing apparatus.

Furthermore, in the present specification, “object” may include a person or an animal, or a part of a person or an animal. For example, the object may include the liver, the heart, the womb, the brain, a breast, the abdomen, or a blood vessel. Furthermore, the “object” may include a phantom. The term “phantom” refers to a material having a volume that is approximately the intensity and effective atomic number of a living thing, and may include a sphere phantom having a property similar to a human body.

Furthermore, in the present specification, “user” refers to a medical professional, such as a doctor, a nurse, a medical laboratory technologist, and/or to an engineer who repairs a medical apparatus, but the user is not limited thereto.

Furthermore, in the present specification, “MRI” refers to an image of an object obtained by using the nuclear magnetic resonance principle.

Furthermore, in the present specification, “pulse sequence” refers to continuity of signals repeatedly applied by an MRI apparatus. A pulse sequence may include a time parameter of a radio frequency (RF) pulse, such as, for example, repetition time (TR) or echo time (TE).

Furthermore, in the present specification, “pulse sequence mimetic diagram” shows an order of events that occur in an MRI apparatus. For example, a pulse sequence mimetic diagram may include any one or more of a diagram showing an RF pulse, a gradient magnetic field, and/or an MR signal according to time.

An MRI system is an apparatus which is configured for acquiring a sectional image of a part of an object by expressing, in a contrast comparison, the strength of a MR signal with respect to a radio frequency (RF) signal generated in a magnetic field having a specific strength. For example, if an RF signal that resonates only a specific atomic nucleus (for example, a hydrogen atomic nucleus) is irradiated for an instant onto the object that is placed in a strong magnetic field and then such irradiation stops, an MR signal is emitted from the specific atomic nucleus, and thus the MRI system may receive the MR signal and acquire an MR image. The MR signal denotes an RF signal emitted from the object. An intensity of the MR signal may be determined according to any one or more of the density of a predetermined atom (for example, hydrogen) included in the object, a relaxation time T1, a relaxation time T2, and blood flow.

MRI systems include characteristics which are different from those of other imaging apparatuses. Unlike image apparatuses such as computed tomography (CT) apparatuses that acquire images based upon a direction of detection hardware, MRI systems may acquire two-dimensional (2D) images or three-dimensional (3D) volume images that are oriented toward an optional point. MRI systems do not expose radiation to objects and examinees, unlike CT apparatuses, X-ray apparatuses, position emission tomography (PET) apparatuses, and single photon emission CT (SPECT) apparatuses, may acquire images having high soft tissue contrast, and may acquire neurological images, intravascular images, musculoskeletal images, and oncologic images that are useful for precisely describing abnormal tissue.

Exemplary embodiments may be applied to any one or more of various medical images such as a magnetic resonance (MR) medical image, a CT medical image, an X-ray medical image, an ultrasound medical image, and a PET medical image, which are obtained by using various medical apparatuses. In the present specification, a description will focus on a medical image which is obtained by an MRI system, but exemplary embodiments are not limited to an MR image.

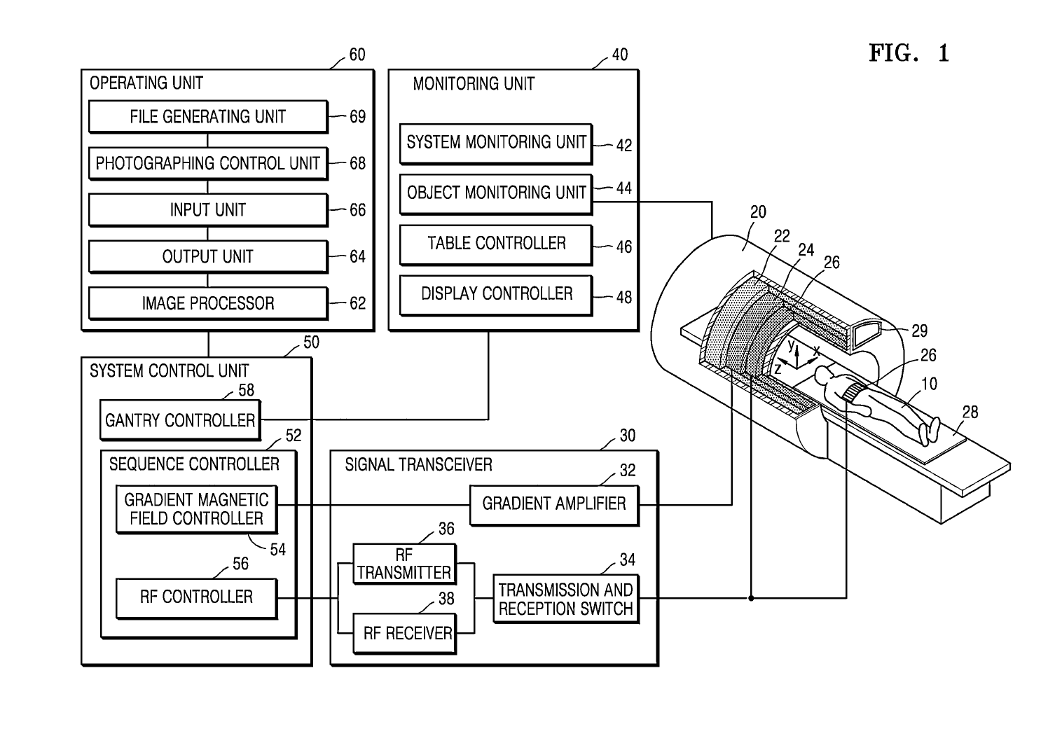

FIG. 1 is a block diagram of a general MRI system. Referring to FIG. 1, the general MRI system may include a gantry 20, a signal transceiver 30, a monitoring unit (also referred to herein as a “monitoring device” and/or as a “monitor”) 40, a system control unit (also referred to herein as a “system controller”) 50, and an operating unit (also referred to herein as an “operator device” and/or as an “operator”) 60.

The gantry 20 blocks electromagnetic waves generated by a main magnet 22, a gradient coil 24, and an RF coil 26 from being externally emitted. A magnetostatic field and a gradient magnetic field are formed at a bore in the gantry 20, and an RF signal is irradiated towards an object 10.

The main magnet 22, the gradient coil 24, and the RF coil 26 may be arranged in a predetermined direction with respect to the gantry 20. The predetermined direction may be a coaxial cylinder direction. The object 10 may be disposed on a table 28 that is capable of being inserted into a cylinder along a horizontal axis of the cylinder.

The main magnet 22 generates a magnetostatic field or a static magnetic field for aligning a direction of magnetic dipole moments of atomic nuclei in the object 10 in a constant direction. A precise and accurate MR image of the object 10 may be obtained when a magnetic field generated by the main magnet 22 is strong and uniform.

The gradient coil 24 includes X, Y, and Z coils configured for generating gradient magnetic fields in X-axis, Y-axis, and Z-axis directions which mutually cross each other at right angles. The gradient coil 24 may provide location information which relates to each region of the object 10 by variably inducing resonance frequencies in correspondence with the regions of the object 10.

The RF coil 26 may irradiate an RF signal toward the object 10, for example, a patient, and receive an MR signal emitted from the object 10. In detail, the RF coil 26 may transmit an RF signal at a same frequency as precessional motion to the patient towards atomic nuclei in precessional motion, stop transmitting the RF signal, and then receive an MR signal emitted from the object 10.

For example, in order to induce an atomic nucleus to transition from a low energy state to a high energy state, the RF coil 26 may generate and apply an electromagnetic wave signal having an RF which corresponds to a type of the atomic nucleus, for example, an RF signal, to the object 10. When the electromagnetic wave signal generated by the RF coil 26 is applied to the atomic nucleus, the atomic nucleus may transition from the low energy state to the high energy state. Then, when electromagnetic waves generated by the RF coil 26 disappear, the atomic nucleus, upon which the electromagnetic waves were applied, transitions from the high energy state to the low energy state, thereby emitting electromagnetic waves having a Larmor frequency. In particular, when an application of the electromagnetic wave signal to the atomic nucleus is stopped, an energy level of the atomic nucleus is changed from a high energy level to a low energy level, and thus the atomic nucleus may emit electromagnetic waves having a Larmor frequency. The RF coil 26 may receive electromagnetic wave signals from atomic nuclei in the object 10.

The RF coil 26 may be realized as one RF transmitting and receiving coil having both a first function of generating electromagnetic waves having a wireless frequency corresponding to a type of an atomic nucleus and a second function of receiving electromagnetic waves emitted from an atomic nucleus. Alternatively, the RF coil 26 may be realized as a transmission RF coil having a function of generating electromagnetic waves having a wireless frequency corresponding to a type of an atomic nucleus, and a reception RF coil having a function of receiving electromagnetic waves emitted from an atomic nucleus.

The RF coil 26 may be fixed to the gantry 20 or may be detachable. When the RF coil 26 is detachable, the RF coil 26 may include an RF coil which is designed for a particular part of the object 10, such as a head RF coil, a chest RF coil, a leg RF coil, a neck RF coil, a shoulder RF coil, a wrist RF coil, or an ankle RF coil.

The RF coil 26 may communicate with an external apparatus via wires and/or wirelessly, and may also perform dual tune communication according to a communication frequency band.

The RF coil 26 may include any one or more of a birdcage coil, a surface coil, and/or a transverse electromagnetic (TEM) coil based on corresponding structures.

The RF coil 26 may include any one or more of a transmission exclusive coil, a reception exclusive coil, and/or a transmission and reception coil based on corresponding methods of transmitting and receiving an RF signal.

The RF coil 26 may include an RF coil which operates in accordance with any one of various numbers of channels, such as 16 channels, 32 channels, 72 channels, and 144 channels.

The gantry 20 may further include a display 29 disposed outside the gantry 20 and a display (not shown) disposed inside the gantry 20. The gantry 20 may provide predetermined information to the user and/or to the object 10 via the display 29 and the display respectively disposed outside and inside the gantry 20.

The signal transceiver 30 may be configured to control the gradient magnetic field formed inside the gantry 20, i.e., in the bore, based on a predetermined MR sequence, and to control transmission and/or reception of an RF signal and an MR signal.

The signal transceiver 30 may include a gradient amplifier 32, a transmission and reception switch 34, an RF transmitter 36, and an RF receiver 38.

The gradient amplifier 32 drives the gradient coil 24 in the gantry 20, and may supply a pulse signal for generating a gradient magnetic field to the gradient coil 24 based on a control of a gradient magnetic field controller 54. By controlling the pulse signal supplied from the gradient amplifier 32 to the gradient coil 24, gradient magnetic fields in X-axis, Y-axis, and Z-axis directions may be composed.

The RF transmitter 36 and the RF receiver 38 may be configured to drive the RF coil 26. The RF transmitter 36 may be configured to supply an RF pulse at a Larmor frequency to the RF coil 26, and the RF receiver 38 may be configured to receive an MR signal received by the RF coil 26.

The transmission and reception switch 34 may be configured to adjust transmitting and receiving directions of the RF signal and the MR signal. For example, the RF signal may be irradiated toward the object 10 via the RF coil 26 during a transmission mode, and the MR signal may be received by the object 10 via the RF coil 26 during a reception mode. The transmission and reception switch 34 may be controlled by a control signal from an RF controller 56.

The monitoring unit 40 may be configured to monitor or control the gantry 20 or devices mounted on the gantry 20. The monitoring unit 40 may include a system monitoring unit (also referred to herein as a “system monitor”) 42, an object monitoring unit (also referred to herein as an “object monitor”) 44, a table controller 46, and a display controller 48.

The system monitoring unit 42 may be configured to monitor and control any one or more of a state of a magnetostatic field, a state of a gradient magnetic field, a state of an RF signal, a state of an RF coil, a state of a table, a state of a device measuring body information of an object, a power supply state, a state of a thermal exchanger, and a state of a compressor.

The object monitoring unit 44 monitors a state of the object 10. In detail, the object monitoring unit 44 may include a camera for observing movement or position of the object 10, a respiration measurer for measuring the respiration of the object 10, an ECG measurer for measuring ECG of the object 10, and/or a temperature measurer for measuring a temperature of the object 10.

The table controller 46 controls a movement of the table 28 where the object 10 is positioned. The table controller 46 may control the movement of the table 28 based on a sequence control of a sequence controller 52. For example, during moving imaging of the object 10, the table controller 46 may continuously or discontinuously move the table 28 based on the sequence control of the sequence controller 52, and thus the object 10 may be photographed in a field of view (FOV) that is larger than that of the gantry 20.

The display controller 48 controls the display 29 and the display respectively outside and inside the gantry 20. In detail, the display controller 48 may turn on and/or off either or both of the display 29 and the display outside and inside the gantry 20, and may control a screen to be output on the display 29 and the display inside the gantry. Further, when a speaker is located inside or outside the gantry 20, the display controller 48 may turn on and/or off the speaker, and/or control the speaker to output sound.

The system control unit 50 may include the sequence controller 52 for controlling a sequence of signals formed in the gantry 20, and a gantry controller 58 for controlling the gantry 20 and devices mounted on the gantry 20.

The sequence controller 52 may include the gradient magnetic field controller 54 for controlling the gradient amplifier 32, and the RF controller 56 for controlling the RF transmitter 36, the RF receiver 38, and the transmission and reception switch 34. The sequence controller 52 may be configured to control the gradient amplifier 32, the RF transmitter 36, the RF receiver 38, and the transmission and reception switch 34 based on a pulse sequence received from the operating unit 60. In this aspect, the pulse sequence includes all information required to control the gradient amplifier 32, the RF transmitter 36, the RF receiver 38, and the transmission and reception switch 34, and, for example, may include information which relates to any one or more of a strength, an application time, and an application timing of a pulse signal applied to the gradient coil 24.

The operating unit 60 requests the system control unit 50 to transmit pulse sequence information while controlling an overall operation of the MRI system.

The operating unit 60 may include an image processor 62 configured for processing an MR signal received from the RF receiver 38, an output unit (also referred to herein as an “output device”) 64, an input unit (also referred to herein as an “input device”) 66, a photographing control unit (also referred to herein as a “photography controller”) 68, and a file generating unit (also referred to herein as a “file generator”) 69.

The image processor 62 processes an MR signal received from the RF receiver 38 so as to generate MR image data which relates to the object 10.

The image processor 62 is configured to perform any one of various signal processes, such as amplification, frequency transformation, phase detection, low frequency amplification, and filtering, on an MR signal received by the RF receiver 38.

The image processor 62 may arrange digital data in a k space (for example, also referred to as a Fourier space or frequency space) of a memory, and rearrange the digital data into image data via 2D or 3D Fourier transformation.

The image processor 62 may perform a composition process and/or a difference calculation process on image data if required. The composition process may include an addition process on a pixel and/or a maximum intensity projection (MIP) process. The image processor 62 may store not only rearranged image data but also image data on which a composition process or difference calculation process is performed, in a memory (not shown) or an external server.

Signal processes applied to MR signals by the image processor 62 may be performed in parallel. For example, a signal process may be performed on a plurality of MR signals received by a multi-channel RF coil in parallel, so as to rearrange the plurality of MR signals as image data.

The output unit 64 may output image data generated or rearranged by the image processor 62 to the user. Further, the output unit 64 may output information which is required in order for the user to manipulate the MRI system, such as user interface (UI), user information, and/or object information. The output unit 64 may include any one or more of a speaker, a printer, a cathode-ray tube (CRT) display, a liquid crystal display (LCD), a plasma display panel (PDP), an organic light-emitting device (OLED) display, a field emission display (FED), a light-emitting diode (LED) display, a vacuum fluorescent display (VFD), a digital light processing (DLP) display, a PFD display, a 3-dimensional (3D) display, and/or a transparent display, and/or any one of various output devices that are well known to one of ordinary skill in the art.

The user may input any one or more of object information, parameter information, a scan condition, a pulse sequence, or information which relates to image composition or difference calculation by using the input unit 66. The input unit 66 may include any one or more of a keyboard, a mouse, a track ball, a voice recognizer, a gesture recognizer, and/or a touch screen, and/or may include any one of other various input devices that are well known to one of ordinary skill in the art.

According to an exemplary embodiment, when capturing a medical image, a user may set a 2D photographing mode and a 3D photographing mode by using the input unit 66. The photographing control unit 68 may output a control signal, which controls 2D photographing and/or 3D photographing, to the system control unit 50 based on a user's setting. The gradient magnetic field controller 54 may generate and output gradient magnetic fields having different waveforms in accordance with a photographing mode.

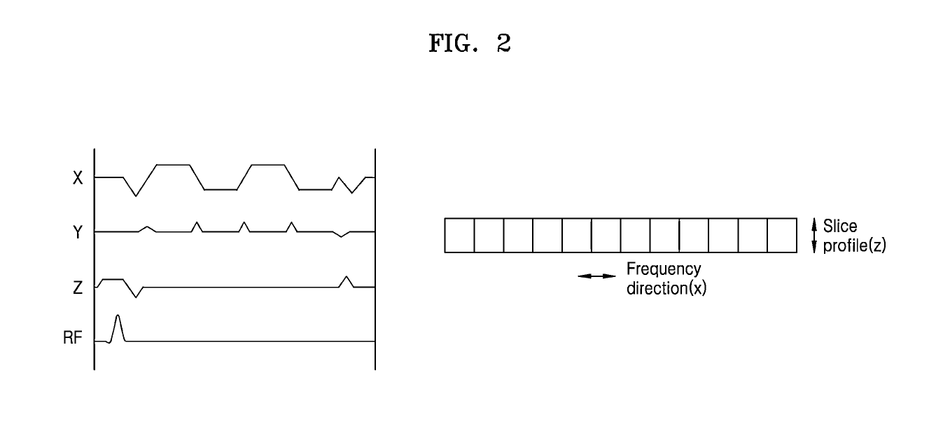

FIG. 2 is a diagram which illustrates an operation of capturing a medical image in a 2D photographing mode, according to an exemplary embodiment.

When capturing a medical image in the 2D photographing mode, an X-axis direction gradient magnetic field, a Y-axis direction gradient magnetic field, a Z-axis direction gradient magnetic field, and an RF signal which respectively have waveforms shown on the left side of FIG. 2 may be output. Moreover, as shown on the right side of FIG. 2, a 2D medical image may be obtained by applying a gradient magnetic field in a Z-axis direction.

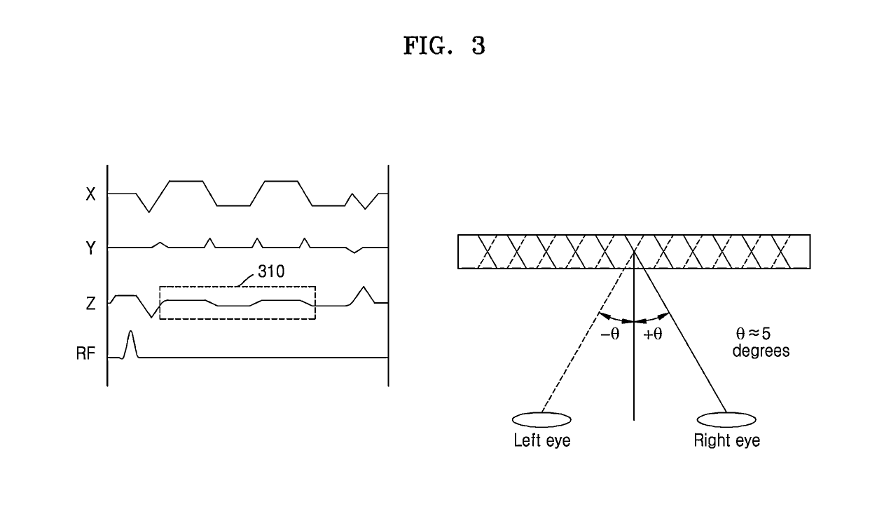

FIG. 3 is a diagram which illustrates an operation of capturing a medical image in a 3D photographing mode, according to an exemplary embodiment.

When capturing a medical image in the 3D photographing mode, an X-axis direction gradient magnetic field, a Y-axis direction gradient magnetic field, a Z-axis direction gradient magnetic field, and an RF signal which respectively have waveforms shown on the left side of FIG. 3 may be output. In order to capture a 3D medical image, the gradient magnetic field control unit 54 may vary a one-direction gradient magnetic field (for example, the Z-axis direction gradient magnetic field) 310 in order to output a left-image gradient magnetic field and a right-image gradient magnetic field, thereby obtaining a left-eye image and a right-eye image. In 3D photographing, the left-image gradient magnetic field and the right-image gradient magnetic field may be applied simultaneously or sequentially.

The file generating unit 69 encodes a captured medical image to generate a file. The file generating unit 69 may store a medical image and additional information together. For example, any one or more of examinee information, photographing setting value information, and medical information measured in photographing may be stored in conjunction with a medical image.

The signal transceiver 30, the monitoring unit 40, the system control unit 50, and the operating unit 60 are separate components in FIG. 1, but it will be apparent to one of ordinary skill in the art that each of respective functions of the signal transceiver 30, the monitoring unit 40, the system control unit 50, and the operating unit 60 may be performed by another component. For example, the image processor 62 converts an MR signal received by the RF receiver 38 into a digital signal, but such a conversion to a digital signal may be directly performed by the RF receiver 38 or the RF coil 26.

The gantry 20, the RF coil 26, the signal transceiver 30, the monitoring unit 40, the system control unit 50, and the operating unit 60 may be connected to each other via wires and/or wirelessly. When they are connected wirelessly, the MRI system may further include an apparatus (not shown) which is configured for synchronizing clocks therebetween. Communication between the gantry 20, the RF coil 26, the signal transceiver 30, the monitoring unit 40, the system control unit 50, and the operating unit 60 may be performed by using any one or more of a high-speed digital interface, such as low voltage differential signaling (LVDS), asynchronous serial communication, such as universal asynchronous receiver transmitter (UART), a low-delay network protocol, such as an error synchronous serial communication or controller area network (CAN), and/or optical communication, and/or any other communication method that is well known to one of ordinary skill in the art.

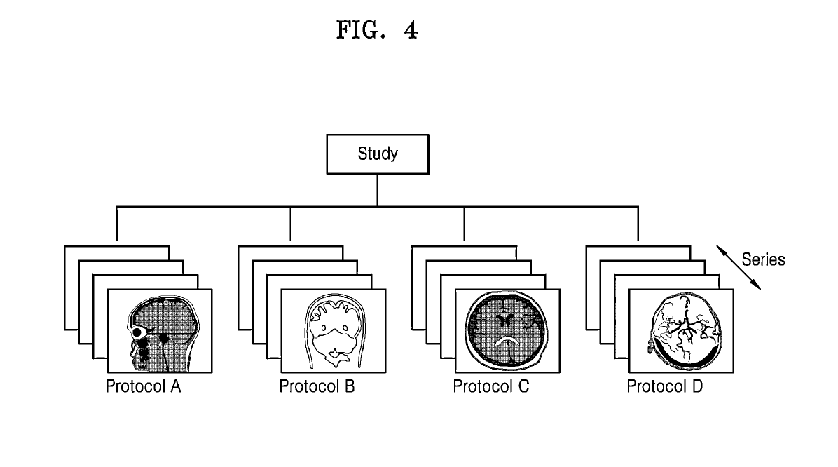

FIG. 4 is a diagram which illustrates a structure of a medical image, according to an exemplary embodiment.

An object, such as a head or a heart for which a medical image is to be captured, is referred to as a study. Each of a plurality of studies is captured by using at least one protocol. The protocol denotes a photographing technique which is implemented in a medical imaging system. Examples of the protocol may include any one or more of photographing techniques such as a cerebrovascular photographing technique, a brain structure photographing technique, an ependymal photographing technique, and a cerebral blood flow photographing technique.

Examples of the protocol may include at least one protocol for the 2D photographing mode and at least one protocol for the 3D photographing mode.

Photographing conditions may be variably set for protocols A, B, C, and D, and a plurality of images may be captured under the photographing conditions. A set of a plurality of images based on the protocols A, B, C, and D is referred to as a series.

According to exemplary embodiments, a 3D medical image includes a plurality of 3D series images that are obtained based on a particular protocol. The plurality of 3D series images may be associated with different respective offset values. Therefore, focal planes of the plurality of 3D series images differ. According to an exemplary embodiment, each of the 3D series images may include a left-eye image and a right-eye image.

Each of the offset values denotes a degree to which a left-eye image and a right-eye image of an object located on a focal plane of a 3D medical image deviate from each other. A three-dimensionality of a focal plane of a 3D medical image is varied based on a level of a corresponding offset value. For example, when an offset value is large, a degree to which an object located on a focal plane is viewed to protrude forward or recede backward from a plane corresponding to a base offset is perceived as being relatively large, and when the offset value is small, the degree to which the object located on the focal plane is viewed to protrude forward or recede backward from the plane corresponding to the base offset is perceived as being relatively small. In this aspect, the plane corresponding to the base offset denotes a plane for which an offset value is equal to zero.

When capturing a medical image, a study may be designated, a photographing protocol may be selected, and a photographing condition may be set, whereupon the medical image may be captured. According to an exemplary embodiment, in an operation of setting a photographing condition in the 3D photographing mode, the number of 3D series images and an interval between focal planes of the 3D series images may be set, and the 3D series images may be captured.

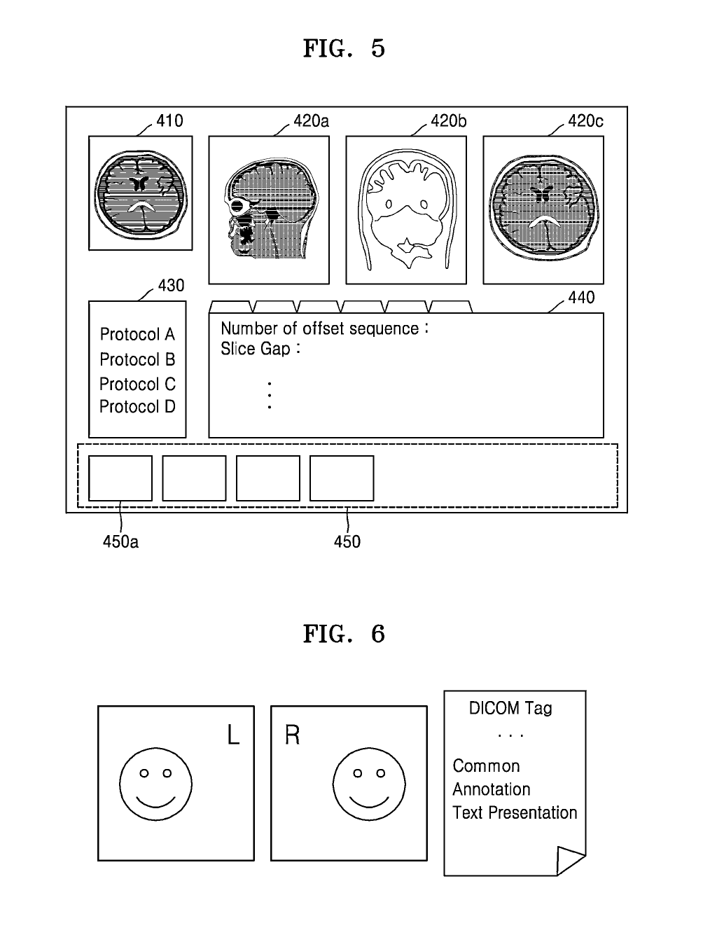

FIG. 5 is a diagram illustrating an example of a user interface screen for capturing a medical image, according to an exemplary embodiment. The user interface screen for capturing a medical image, according to an exemplary embodiment, includes a live view region 410, a plurality of reproduction regions 420a, 420b, and 420c, a protocol selection region 430, a setting region 440, and a thumbnail region 450. According to an exemplary embodiment, the user interface screen may be displayed by the output unit 64 (see FIG. 1) of the MRI system. According to another exemplary embodiment, the user interface screen may be connected to the MRI system, and may be displayed by a display unit of a console, a computer, or a notebook computer, which provides a user interface for the MRI system.

The live view region 410 displays a live view image while an object is being photographed. The live view image may be output from the image processor 62 (see FIG. 1) of the MRI system.

The reproduction regions 420a, 420b, and 420c display captured images of the object, respectively. According to an exemplary embodiment, the reproduction regions 420a, 420b, and 420c may display cross-sectional images in respective directions. For example, as illustrated in FIG. 4, the reproduction region 420a may be a sagittal image reproduction image, the reproduction region 420b may be a coronal image reproduction image, and the reproduction region 420c may be an axial image reproduction image.

The protocol selection region 430 displays at least one protocol which is selectable by a user, and provides a user interface that enables the user to select a protocol. The protocol denotes a photographing technique for a medical image. Examples of the protocol may include photographing techniques such as a cerebrovascular photographing technique, a brain structure photographing technique, an ependymal photographing technique, and a cerebral blood flow photographing technique.

The setting region 440 provides an interface which is used to set a photographing condition, such as, for example, a photographing parameter. The user may set, for example, parameters such as the presence of 3D photographing (a 3D enable option), a 3D orientation, 3D phase encoding, a 3D effect offset value, a 3D slice gap, a 3D slice thickness, and the number of 3D series images to be captured (number of offset sequence). The setting region 440 may provide an interface which is used to set a photographing condition for a photographing operation, and display information such as a photographing condition, additional information, and an annotation associated with an image that is displayed while reproducing a captured image.

The thumbnail region 450 displays thumbnails 450a of captured medical images. By selecting one of the thumbnails 450a, a medical image corresponding to the selected thumbnail 450a may be reproduced and displayed in the thumbnail region 450. The thumbnails 450a may correspond to respective series images that are captured based on different protocols. FIG. 6 is a diagram illustrating a structure of a 3D series medical image, according to an exemplary embodiment. Series images included in the 3D series medical image may include any one or more of a left-eye image (L) (image for left eye), a right-eye image (R) (image for right eye), and tag information (DICOM Tag).

The tag information (DICOM Tag) may be stored for the 3D medical image, and/or may be stored for each of the 3D series images. The tag information (DICOM Tag) may be stored as, for example, a type of a digital imaging and communication in medicine (DICOM) tag.

The tag information (DICOM Tag) may include, for example, any one or more of an annotation, additional information, and information which relates to the following series images.

Information which relates to 3D series images may include information (including photographing conditions for the 3D series images) which relates to a specific single image.

<Information about Series Image>
Number of offset sequences: Number of 3D series images
Offset sequence ID: Offset sequence ID given to each 3D series image
Number of displayed image in series: Index information of corresponding series image
Plane offset direction: Horizontally shifted direction
Plane offset value: Offset value

An annotation denotes information relating to an object. The annotation may include, for example, any one or more of information analyzed from an application, information obtained via image analysis, analysis information which relates to a lesion, information input by a user, and information input by an analyzer. An example of the annotation is as follows:

<Annotation>
Entry for left eye annotation: Basic information for left eye annotation
Entry for right eye annotation: Basic information for right eye annotation
Annotation offset sequence ID: Offset sequence ID of annotation
Fixed offset during pop up flag: Flag for showing annotation as constant value when pop up is displayed on screen
Offset value during pop up: Offset value capable of being applied according to “fixed offset during pop up flag” (when fixed offset during pop up flag indicates constant value being shown, annotation is displayed as an offset value that is shown in offset value during pop up. Fixed offset during pop up flag indicates constant value not being shown, and offset value shown in offset value during pop up is not applied.)
Annotation offset sequence ID reference: Offset sequence ID referred to for corresponding annotation

Additional information denotes information which relates to any one or more of a patient, a medical imaging system, and an object. The additional information includes, for example, any one or more of patient information, study information, series information, image information, and system information. Examples of the additional information are as follows:

<Additional Information>
Patient: Patient name, ID, birth date, patient comments, sex, pregnancy status, contrast allergies, address, smoking status, additional comments, history
Study-related information: Study ID, study date, study time, physician name, study ID, patient age, weight, size, study description, physician record
Series-related information: Modality, series ID, series name, series date, series time, protocol name, series description, body part, patient position, physician name, operator name
Image-related information: Image number, patient orientation, content date, content time, image type, acquisition number, acquisition date, acquisition time
System-related information: Manufacturer, institution name, institution address, institutional department name, manufacturer model name, software version, device serial number, spatial resolution, date of last calibration time of last calibration
Detailed MR: Scanning Sequence, sequence variant, scan option, acquisition type, angio flag, repetition time, echo time
Entry for left eye Text Presentation
Entry for right eye Text presentation
Text Presentation offset sequence ID
Fixed offset during pop up flag
offset value during pop up
Text Presentation sequence ID reference: Offset sequence ID to be referred to for corresponding text presentation

According to an exemplary embodiment, a plurality of 3D series images included in a 3D medical image may be stored in one file. For example, tag information (DICOM tag) corresponding to a plurality of 3D series images in common may be stored in a file which corresponds to the 3D medical image. As another example, a plurality of 3D series images may be stored in one file, and tag information (DICOM tag) respectively corresponding to the plurality of 3D series images may be separately provided and stored in the file. As another example, the tag information (DICOM tag) corresponding to the plurality of 3D series images in common and the tag information (DICOM tag) respectively corresponding to the plurality of 3D series images may be stored in the file which corresponds to the 3D medical image.

3D medical images may be managed in units of a patient, in units of a study, or in units of a series. In particular, the 3D medical images may be managed by using any one or more of various schemes.

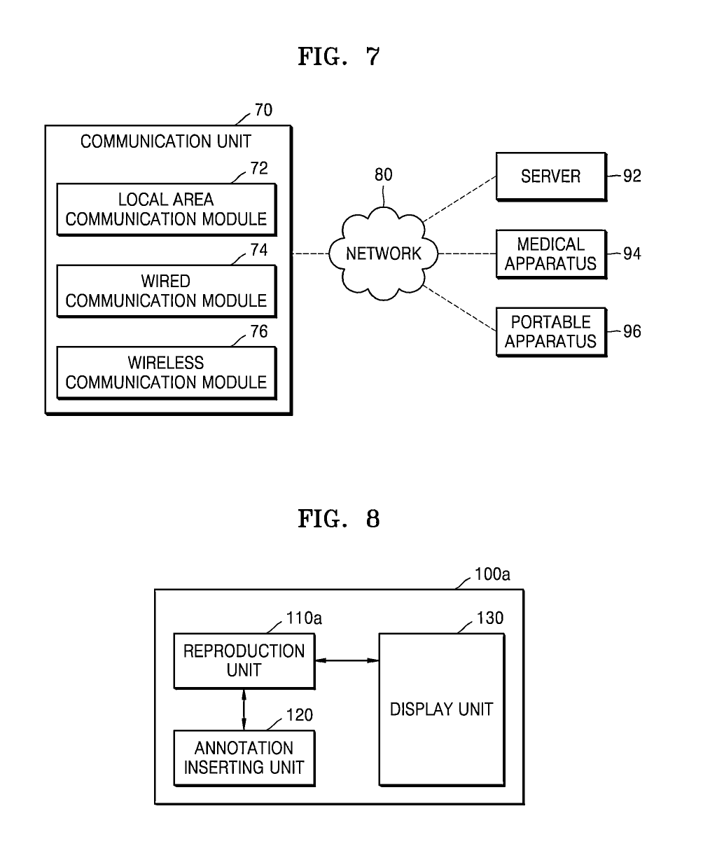

FIG. 7 is a block diagram of a communication unit (also referred to herein as a “communicator”) 70, according to an exemplary embodiment.

The communication unit 70 may be connected to at least one of the gantry 20, the signal transceiver 30, the monitoring unit 40, the system control unit 50, and the operating unit 60 of FIG. 1.

The communication unit 70 may transmit and/or receive data to or from a hospital server or another medical apparatus in a hospital connected through a picture archiving and communication system (PACS), and perform data communication according to the DICOM standard.

As illustrated in FIG. 7, the communication unit 70 may be connected to a network 80 via wires or wirelessly in order to communicate with an external server 92, an external medical apparatus 94, and/or an external portable apparatus 96.

In detail, the communication unit 70 may transmit and/or receive data related to the diagnosis of an object via the network 80, and may also transmit and receive a medical image captured by the external medical apparatus 94, such as a CT, an MRI, or an X-ray apparatus. In addition, the communication unit 70 may receive a diagnosis history and/or a treatment schedule of the object from the external server 92 in order to facilitate a determination of a diagnosis of the object. The communication unit 70 may perform data communication not only with the external server 92 or the external medical apparatus 94 in a hospital, but also with the external portable apparatus 96, such as any one or more of a mobile phone, a personal digital assistant (PDA), and/or a laptop of a doctor or customer.

Further, the communication unit 70 may transmit information which relates to a malfunction of the MRI system or to a medical image quality to a user via the network 80, and receive feedback from the user.

The communication unit 70 may include at least one component enabling communication with an external apparatus, such as, for example, a local area communication module 72, a wired communication module 74, and a wireless communication module 76.

The local area communication module 72 is a module which is configured for performing local area communication with a device within a predetermined distance. Examples of local area communication technology include a wireless local area network (LAN), Wi-Fi, Bluetooth, ZigBee, Wi-Fi direct (WFD), ultra wideband (UWB), infrared data association (IrDA), Bluetooth low energy (BLE), and near field communication (NFC), but are not limited thereto.

The wired communication module 74 is a module which is configured for performing communication by using an electric signal or an optical signal. Examples of wired communication technology include wired communication technologies using a pair cable, a coaxial cable, and an optical fiber cable, and other well-known wired communication technologies.

The wireless communication module 76 is configured to transmit and/or receive a wireless signal to or from at least one of a base station, an external apparatus, and a server in a mobile communication network. In particular, the wireless signal may include data in any one of various formats which correspond to transmitting and receiving a voice call signal, a video call signal, and a text/multimedia message.

FIG. 8 is a diagram illustrating a structure of a medical image reproducing apparatus 100a, according to an exemplary embodiment. The medical image reproducing apparatus 100a according to an exemplary embodiment includes a reproduction unit (also referred to herein as a “reproduction device” and/or as a “reproducer”) 110a, an annotation inserting unit (also referred to herein as an “annotation inserter”) 120, and a display unit (also referred to herein as a “display device” and/or as a “display”) 130.

The reproduction unit 110a decodes a medical image file to effect reproduction. The medical image file includes a 2D medical image file and a 3D medical image file. The 3D medical image file includes a left-eye image and a right-eye image. The reproduction unit 110a simultaneously or sequentially reproduces the left-eye image and the right-eye image in order to reproduce the 3D medical image file.

A medical image file may include additional information associated with a medical image. The additional information may include, for example, any one or more of medical information measured in photographing, information which relates to an examinee, and photographing setting value information.

The annotation inserting unit 120 inserts an annotation into the 3D medical image. In particular, the annotation denotes information which relates to an object. According to the present exemplary embodiment, when reproducing the 3D medical image, the annotation inserting unit 120 inserts the annotation on the basis of an offset value indicating a 3D effect of the 3D medical image. The annotation may be inserted by applying the offset value to the left-eye image and the right-eye image.

According to an exemplary embodiment, the annotation may be marked on a certain position of the 3D medical image based on a user input. The user input includes any one or more of various inputs, such as, for example, an input that issues a command to mark the annotation, an input for selecting a certain position of the 3D medical image, and an input for selecting a certain object of the 3D medical image.

According to another exemplary embodiment, when reproducing a 3D medical image file, the annotation may be automatically marked on a certain position of the 3D medical image.

According to another exemplary embodiment, when a user selects a certain portion or object of the 3D medical image, the annotation inserting unit 120 may read annotation data associated with the selected portion or object, and insert the annotation data into the 3D medical image. For example, when the user selects a frontal lobe from a brain MR 3D image, annotation data corresponding to the frontal lobe may be inserted into the 3D medical image. As another example, when the user selects a certain part of a blood vessel from a blood vessel MR 3D image, annotation data corresponding to the selected part may be inserted into the 3D medical image.

According to another exemplary embodiment, when 3D medical images for a plurality of focal planes are rendered in accordance with a user input, the reproduction unit 110a may change a corresponding focal plane so as to reproduce a corresponding 3D medical image based on the user input. In this case, the annotation inserting unit 120 may insert an annotation in order for the annotation to be located on a corresponding focal plane. According to an exemplary embodiment, a focal plane of a 3D medical image is changed by changing a reproduced 3D series image. In this case, an offset value which relates to the reproduced 3D series image is applied to the annotation, which is inserted into the reproduced 3D series image. In addition, the annotation may be inserted into a left-eye image and right-eye image of the reproduced 3D series image based on the offset value of the reproduced 3D series image.

The display unit 130 displays the left-eye image and the right-eye image in order to display the 3D medical image. The display unit 130 may include, for example, any one or more of a CRT display, an LCD, a PDP, an OLED display, a FED, an LED display, a VFD, a DLP display, a PFD, a 3D display, a transparent display, and/or the like.

According to exemplary embodiments, an annotation is inserted to be located on a focal plane of a 3D medical image, thereby decreasing eye fatigue of a user viewing the 3D medical image. When a depth of a subject and a depth of an annotation are mismatched in a 3D medical image, there is a difficulty which arises from the fact that a user separately adjusts a focal point to each of the subject and the annotation, and views the 3D medical image. In addition, an annotation is inserted to be suitable for a depth of a subject in a 3D medical image, thereby decreasing eye fatigue of a user's eyes.

The medical image reproducing apparatus 100a according to one or more exemplary embodiments may be implemented with any one or more of a personal computer (PC), a tablet PC, a notebook computer, a smartphone, and/or the like. In another exemplary embodiment, the medical image reproducing apparatus 100a may include the image processor 62 and the output unit 64 of the MRI system. In this case, the reproduction unit 110a and the annotation inserting unit 120 may be implemented as the image processor 62, and the display unit 130 may be implemented as the output unit 64.

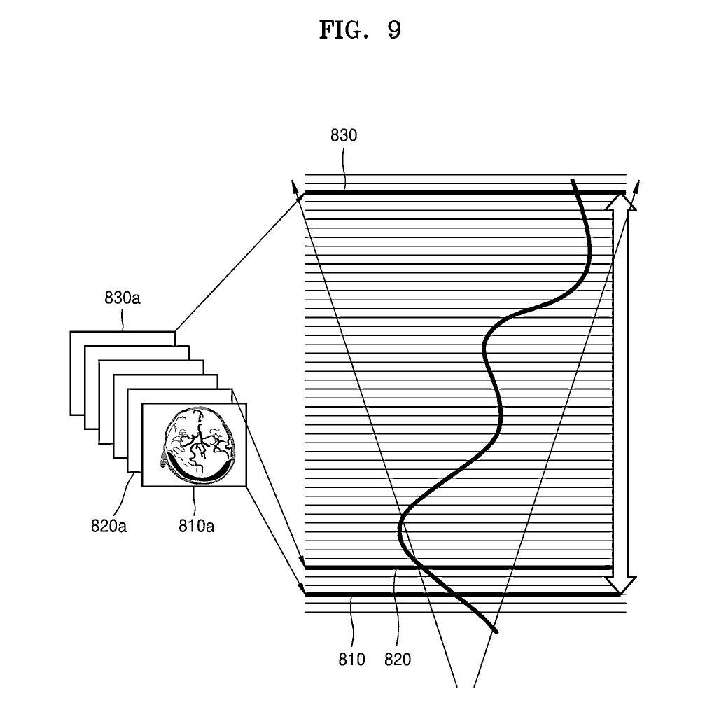

FIG. 9 is a diagram which illustrates an operation of inserting an annotation, according to an exemplary embodiment. In FIG. 9, medical images 810a, 820a, and 830a shown on the left side indicate 3D series images for which focal planes differ. The right side of FIG. 9 illustrates focal planes 810, 820, and 830 of the respective 3D series images 810a, 820a, and 830a.

According to one or more exemplary embodiments, when inserting an annotation into a 3D medical image, the annotation is inserted to be located on a focal plane of the 3D medical image. For example, the medical image 810a is a 3D series image for which a focal point is adjusted to the focal plane 810. According to the present exemplary embodiment, when reproducing the 3D series image 810a, the annotation inserting unit 120 inserts the annotation to be located on the focal plane 810. Similarly, the 3D series image 820a is a 3D series image for which a focal point is adjusted to the focal plane 820, and when reproducing the 3D series image 820a, the annotation inserting unit 120 inserts the annotation to be located on the focal plane 820. Further, when reproducing the 3D series image 830a, the annotation inserting unit 120 inserts the annotation to be located on the focal plane 830.

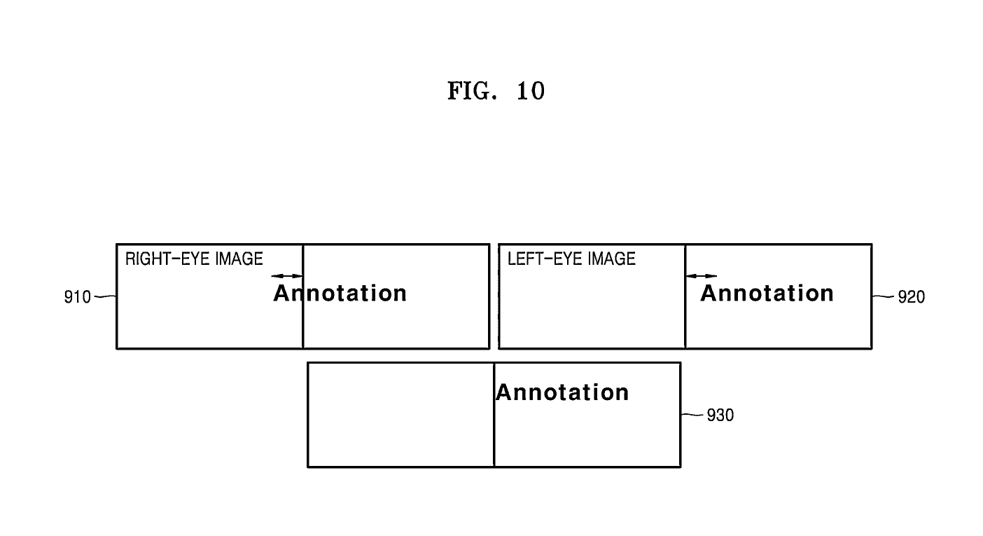

FIG. 10 is a diagram which illustrates an operation of inserting an annotation, according to an exemplary embodiment.

According to an exemplary embodiment, when inserting an annotation, the annotation is inserted based on an offset value corresponding to a reproduced 3D series image. According to an exemplary embodiment, when it is desired to insert the annotation as in an image 930, with respect to the image 930, the annotation may be shifted by the offset value in a first direction and inserted in a right-eye image 910, and the annotation may be shifted by the offset value in a second direction and inserted in a left-eye image 920. Here, the second direction is opposite to the first direction.

According to an exemplary embodiment, each of the first and second directions may be indicated by a sign of the offset value. For example, when the offset value is a positive (+) value, the first direction may be right, and the second direction may be left. Conversely, when the offset value is a negative (−) value, the first direction may be left, and the second direction may be right.

According to another exemplary embodiment, each of the first and second directions may be recorded as a separate parameter (for example, slice direction information) in the 3D medical image file.

When capturing a 3D medical image, the offset value may be stored as a photographing setting value in the 3D medical image file in conjunction with the 3D medical image.

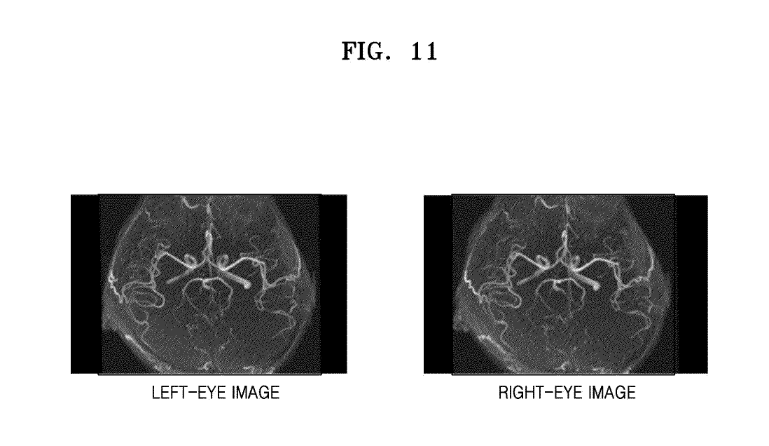

FIG. 11 is a diagram illustrating an example of a generated 3D medical image, according to an exemplary embodiment.

According to an exemplary embodiment, a left-eye image and a right-eye image illustrated in FIG. 11 are generated for each of a plurality of 3D series images. The left-eye image and the right-eye image may be alternately or simultaneously displayed. Further, according to an exemplary embodiment, an annotation is marked as if the annotation is located on a focal plane of a reproduced 3D series image. For example, when a 3D series image for which a focal point is adjusted to a particular object or part is displayed, an annotation associated with the particular object or part for which the focal point is adjusted may be marked on a plane such as the particular object or part. Therefore, a user may view the annotation, which is associated with the particular object or part, from the same plane as the particular object or part. Due to such a configuration, in exemplary embodiments, vertigo or discomfort is reduced or prevented when viewing a 3D medical image.

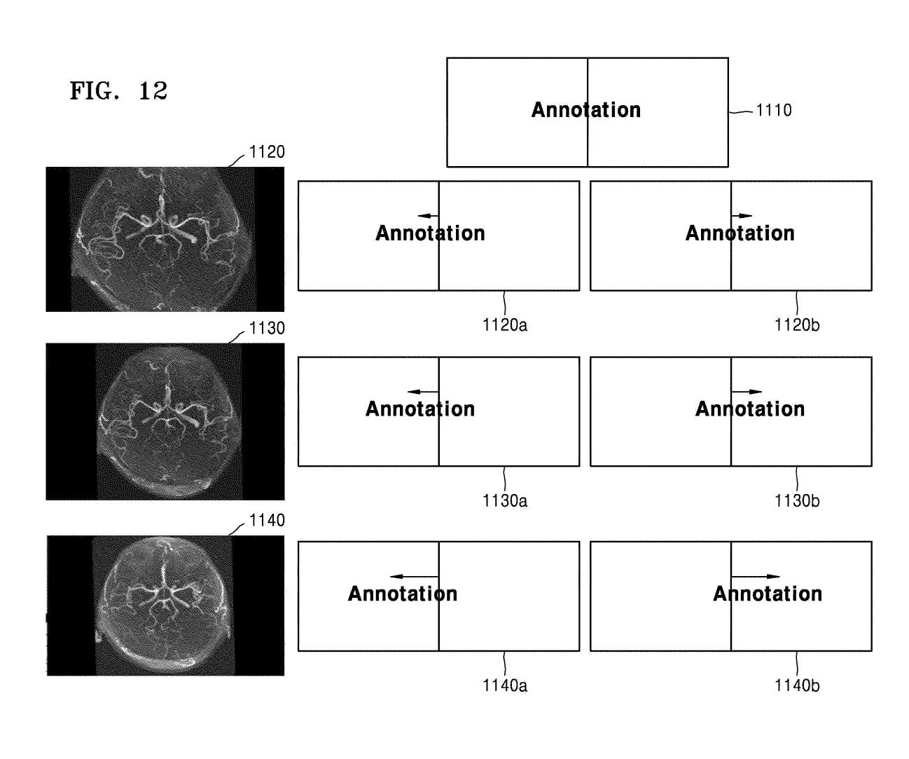

FIG. 12 is a diagram which illustrates an operation of inserting an annotation, according to an exemplary embodiment.

When inserting a 3D medical image, by changing a shift value of an annotation, the annotation inserting unit 120 may arrange the annotation on a desired focal plane. FIG. 12 illustrates an operation of inserting the annotation as in an image 1110. Images 1120, 1130, and 1140 respectively indicate 3D series images having different focal planes, as described above with reference to FIG. 9. When adjusting a focal plane of the annotation, as a plane with the annotation located thereon becomes farther away from a plane having a base offset value, a degree to which the annotation is shifted increases, and as the plane with the annotation located thereon becomes closer to the plane having the base offset value, the degree to which the annotation is shifted decreases. Here, the base offset value may be equal to zero. For example, when the focal planes of the respective 3D series images become farther away from the plane having the base offset value in the order of the images 1120, 1130, and 1140, the degree to which the annotation is shifted increases in the order of the images 1120, 1130, and 1140.

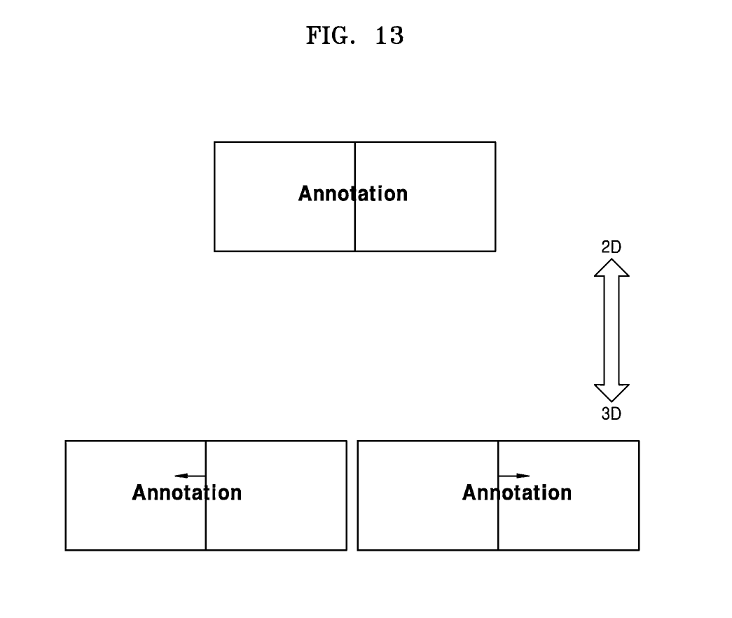

FIG. 13 is a diagram illustrating an example of reproducing a medical image in a 2D mode and a 3D mode, according to an exemplary embodiment.

According to an exemplary embodiment, a medical image may be reproduced in the 2D mode or the 3D mode according to a selection by a user. In this case, the medical image may be separately stored for the 2D mode and the 3D mode. A 2D-mode medical image and a 3D-mode medical image may be stored in the same file, and may be respectively stored in different files. Further, the 2D-mode medical image and the 3D-mode medical image may be stored in the same series.

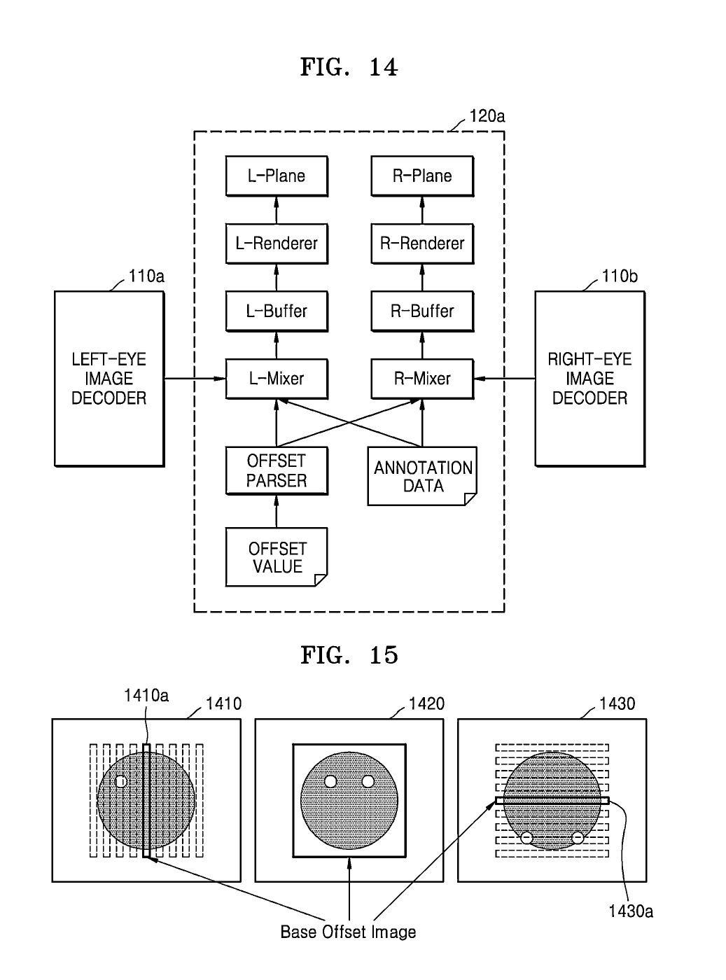

FIG. 14 is a diagram illustrating an example of each of reproduction units 110a and 110b and an annotation inserting unit 120a of a medical image reproducing apparatus 100a, according to an exemplary embodiment.

The reproduction unit 110a according to an exemplary embodiment may include a left-eye image decoder 110a, and the reproduction unit 110b according to an exemplary embodiment may include a right-eye image decoder 110b. The left-eye image decoder 110a decodes a left-eye image of a 3D series image stored in a 3D medical image file, and outputs the decoded image to an L-mixer of the annotation inserting unit 120a. The right-eye image decoder 110b decodes a right-eye image of a 3D series image stored in the 3D medical image file, and outputs the decoded image to an R-mixer of the annotation inserting unit 120a.

The annotation inserting unit 120a respectively receives the left-eye image and the right-eye image from the left-eye image decoder 110a and the right-eye image decoder 110b, and inserts an annotation into each of the left-eye image and the right-eye image. The annotation inserting unit 120a reads an offset value of a first-reproduced 3D series image from the 3D medical image file, and outputs the offset value to the L-mixer and the R-mixer via an offset parser. In addition, the annotation inserting unit 120a reads annotation data from the 3D medical image file, and outputs the annotation data to the L-mixer and the R-mixer.

The L-mixer inserts the annotation into the left-eye image, and the R-mixer inserts the annotation into the right-eye image. In this case, the L-mixer shifts the annotation to a right side by the offset value and inserts the shifted annotation, and the R-mixer shifts the annotation to a left side by the offset value and inserts the shifted annotation. The annotation may be inserted by synthesizing images.

The annotation-inserted left-eye image is temporarily stored in an L-buffer, and is transferred to and stored in an L-plane via an L-renderer. The annotation-inserted right-eye image is temporarily stored in an R-buffer, and is transferred to and stored in an R-plane via an R-renderer. The left-eye image and the right-eye image, which are respectively stored in the L-plane and the R-plane, are transferred to and displayed by the display unit 130.

FIG. 15 is a diagram which illustrates an operation of expressing an offset, according to an exemplary embodiment. Reference numeral 1410 refers to a medical image viewed in an x direction, reference numeral 1420 refers to a medical image viewed in a y direction, and reference numeral 1430 refers to a medical image viewed in a z direction.

According to an exemplary embodiment, the offset value may be expressed with respect to a base offset image. For example, when viewed in the x direction, a central focal plane 1410a of a plurality of shown focal planes is set as an x-direction base offset image, and when viewed in the z direction, a central focal plane 1430a of a plurality of shown focal planes is set as a z-direction base offset image.

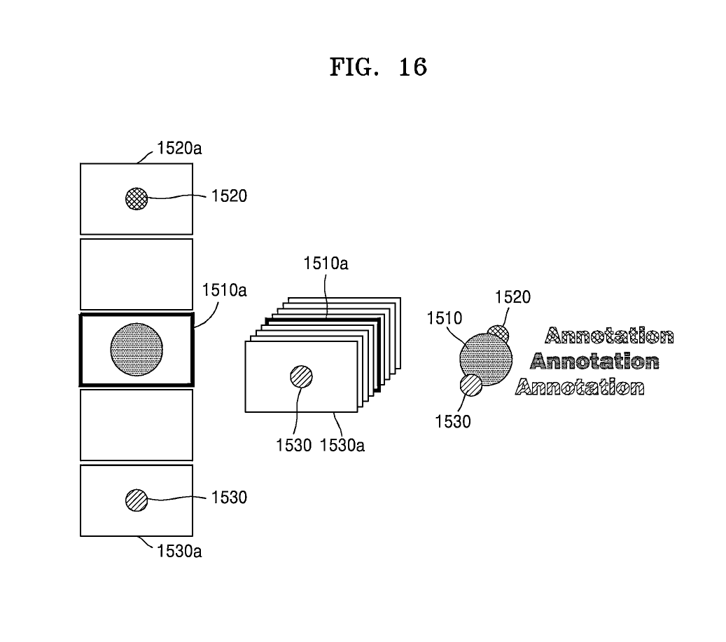

FIG. 16 is a diagram which illustrates an operation of arranging an object and an annotation on focal planes, according to an exemplary embodiment.

According to an exemplary embodiment, as illustrated in FIG. 16, a negative offset value is given to a focal plane 1520a that is further back than a base offset image 1510a, and a positive offset value is given to a focal plane 1530a that is further forward than the base offset image 510a, thereby expressing an offset value. In this case, in a left-eye image and a right-eye image, an annotation may be shifted by an offset value which relates to a focal plane, for which a current focal point is adjusted, with respect to the base offset image 510a, and marked.

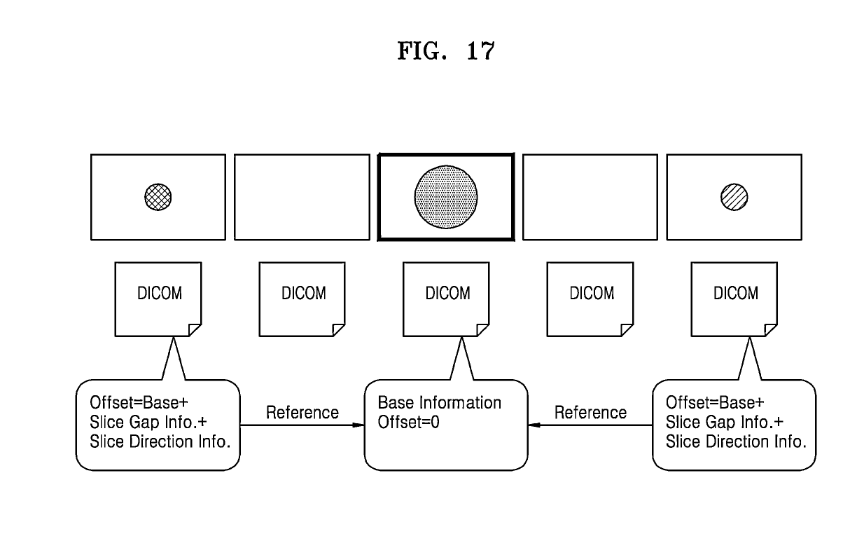

FIG. 17 is a diagram which illustrates an operation of expressing an offset value, according to an exemplary embodiment.

According to an exemplary embodiment, information (Base Information) which relates to a base offset image, offset value information (Slice Gap Info.), and slice direction information (Slice Direction Info.) may be added into a DICOM tag, for expressing an offset value with respect to the base offset image. In particular, the offset value information (i.e., Slice Gap Info.) may indicate a degree to which a left-eye image and a right-eye image are shifted with respect to the base offset image. The slice direction information (i.e., Slice Direction Info.) may indicate a corresponding medical image being forward or backward with respect to the base offset image.

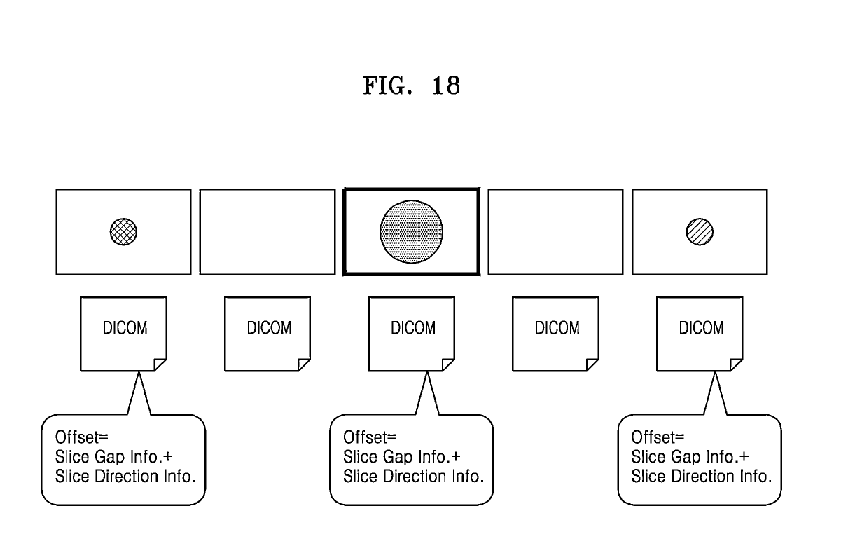

FIG. 18 is a diagram which illustrates an operation of expressing an offset value, according to another exemplary embodiment.

According to an exemplary embodiment, an offset value may be expressed as an absolute value. In this case, the offset value may be expressed as an absolute value into which a slice gap between the left-eye image and the right-eye image is converted. For example, as illustrated in FIG. 18, the offset value information (i.e., Slice Gap Info.) and the slice direction information (i.e., Slice Direction Info.) may be added into the DICOM tag, and the offset value may be recorded.

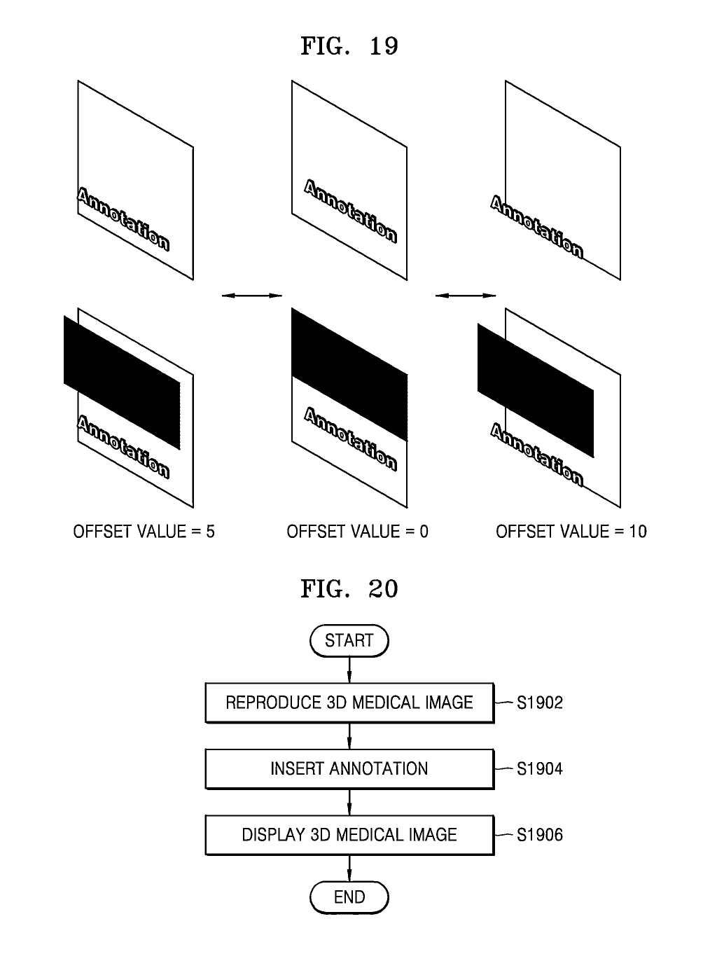

FIG. 19 is a diagram which illustrates an operation of expressing a 3D annotation, according to an exemplary embodiment.

As illustrated in FIG. 19, different 3D effects of an annotation may be shown according to an offset value. For example, the annotation may be expressed as if the annotation is located on a more forward focal plane when the offset value is set to 5 than when the offset value is set to 0, and the annotation may be expressed as if the annotation is located on a more forward focal plane when the offset value is set to 10 than when the offset value is set to 5.

FIG. 20 is a flowchart of a 3D medical image reproducing method, according to an exemplary embodiment.

In operation S1902, the 3D medical image reproducing method according to an exemplary embodiment first decodes a file which includes a 3D medical image in order to obtain a left-eye image and a right-eye image, thereby generating the 3D medical image. The 3D medical image may include a plurality of 3D series images, each of which may include a left-eye image and a right-eye image. One of the plurality of 3D series images may be selected by automatic selection or based on a selection by a user and reproduced.

Subsequently, an annotation is inserted into each of the left-eye image and the right-eye image in operation S1904. A position of the annotation may be determined according to an offset value of the reproduced 3D series image, and the annotation may be thusly inserted into each of the left-eye image and the right-eye image. For example, when inserting the annotation into the left-eye image, the annotation may be shifted by the offset value in a right direction from the determined position and inserted, and when inserting the annotation into the right-eye image, the annotation may be shifted by the offset value in a left direction from the determined position and inserted.

Subsequently, by displaying the left-eye image and the right-eye image, the 3D medical image is displayed in operation S1906.

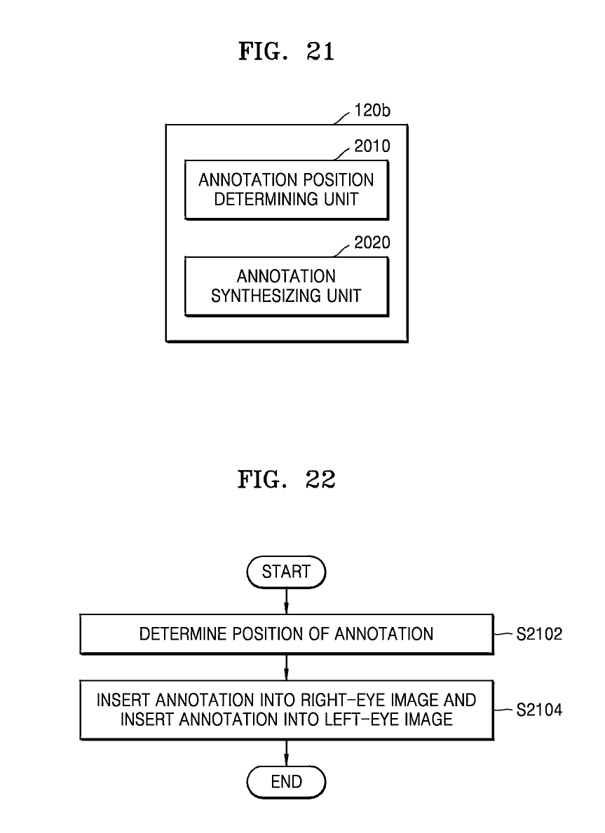

FIG. 21 is a diagram illustrating a structure of an annotation inserting unit 120b, according to another exemplary embodiment. The annotation inserting unit 120b according to another exemplary embodiment includes an annotation position determining unit (also referred to as an “annotation position determiner”) 2010 and an annotation synthesizing unit (also referred to as an “annotation synthesizer”) 2020.

The annotation position determining unit 2010 determines a position of the annotation. Here, the position of the annotation denotes a position of the annotation before a 3D effect is given to the annotation. For example, the annotation position determining unit 2010 may arrange the annotation near an object related to the annotation. As another example, the annotation position determining unit 2010 may arrange the annotation at a position selected by a user.

The annotation synthesizing unit 2020 shifts the annotation by the offset value in a first direction in order to insert the shifted annotation into the right-eye image, and shifts the annotation by the offset value in a second direction (which is opposite to the first direction) in order to insert the shifted annotation into the left-eye image. The offset value may be stored in a 3D medical image file in conjunction with the 3D medical image.

FIG. 22 is a flowchart of an operation of inserting an annotation, according to an exemplary embodiment.

According to an exemplary embodiment, a position of an annotation is first determined in operation S2102. Subsequently, the annotation is shifted by an offset value in a first direction and inserted into the right-eye image, and the annotation is shifted by the offset value in a second direction (which is opposite to the first direction) and inserted into the left-eye image, in operation S2104.

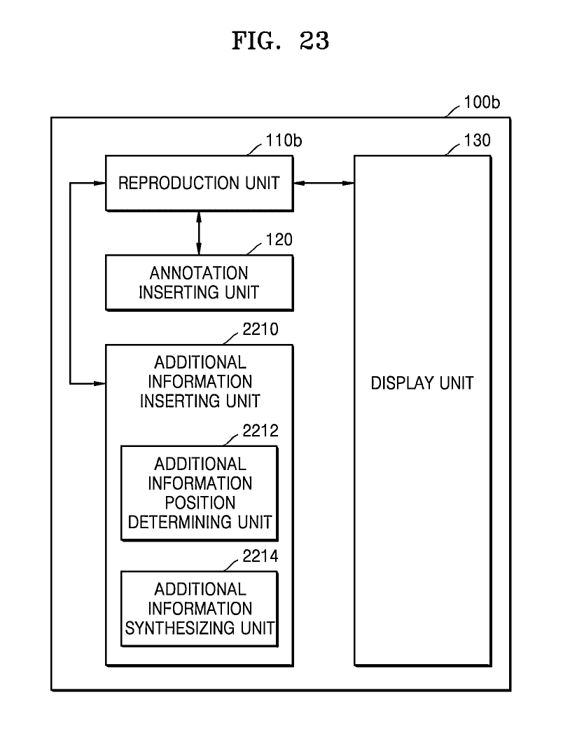

FIG. 23 is a diagram illustrating a structure of a medical image reproducing apparatus 100b, according to another exemplary embodiment. The medical image reproducing apparatus 100b according to another exemplary embodiment includes a reproduction unit 110b, an annotation inserting unit 120, an additional information inserting unit 2210, and a display unit 130.

The reproduction unit 110b decodes a medical image file in order to effect reproduction. The medical image file includes a 2D medical image file and a 3D medical image file. The 3D medical image file may include a plurality of 3D series images, each of which may include a left-eye image and a right-eye image. The reproduction unit 110b simultaneously or sequentially reproduces the left-eye image and the right-eye image in order to reproduce the 3D medical image file.

The annotation inserting unit 120 inserts an annotation into the 3D medical image. According to the present exemplary embodiment, when reproducing the 3D medical image, the annotation inserting unit 120 inserts the annotation on the basis of an offset value which indicates a 3D effect of a reproduced 3D series image. When inserting the annotation into each of the left-eye image and the right-eye image, the annotation may be shifted by the offset value and inserted.

The additional information inserting unit 2210 inserts additional information into the 3D medical image. The additional information denotes information associated with the 3D medical image which differs from the annotation. For example, the additional information may include any one or more of patient information, a photographing date, a photographing place, a photographing setting value, equipment information, and photographer information.

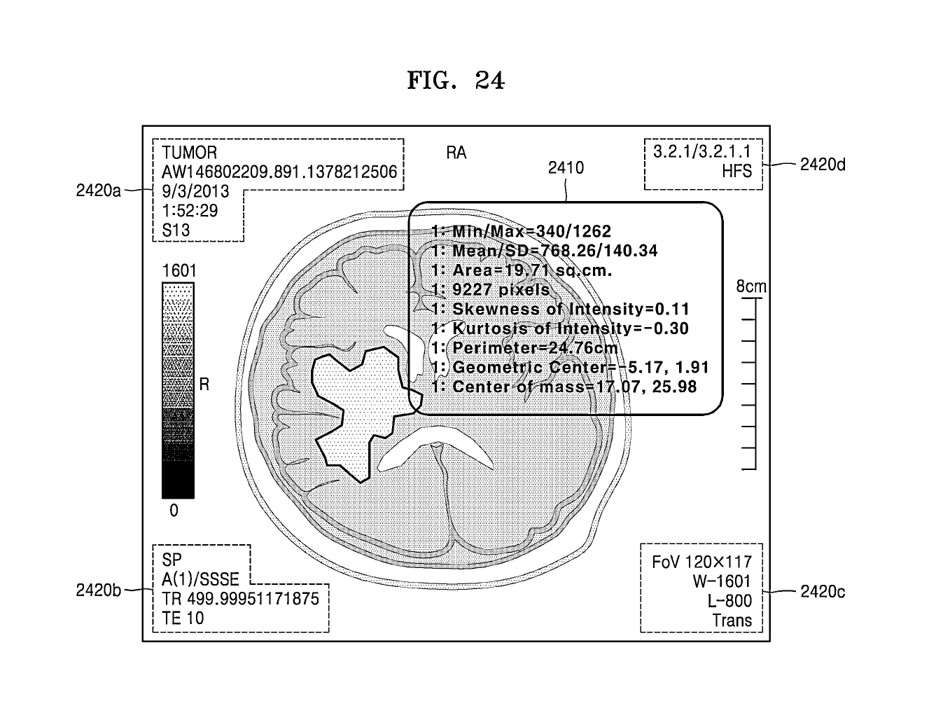

According to an exemplary embodiment, the additional information inserting unit 2210 may insert the additional information into the 3D medical image on the basis of an offset value which relates to the reproduced 3D series image. The annotation and the additional information are set to have the same offset value, and thus, the additional information is arranged on the same focal plane as that of the annotation. In the present exemplary embodiment, since the annotation and the additional information are arranged on the same focal plane, fatigue of a user's eyes is reduced. FIG. 24 is a diagram which illustrates a structure of a medical image with additional information inserted thereinto, according to an exemplary embodiment.

According to an exemplary embodiment, an annotation 2410 and pieces of additional information 2420a, 2420b, 2420c, and 2420d may be inserted into the 3D medical image. All the annotation 2410 and the pieces of additional information 2420a, 2420b, 2420c, and 2420d may be inserted into the 3D medical image on the basis of the offset value of the reproduced 3D series image. Due to such a configuration, in a 3D medical image, an annotation and additional information may be arranged on the same focal plane.

The additional information inserting unit 2210 may include an additional information position determining unit 2212 and an additional information synthesizing unit 2214.

The additional information position determining unit 2212 determines a position of additional information. Here, the position of the additional information denotes a position of the additional information before a 3D effect is given to the additional information. The additional information may be arranged at, for example, a predetermined position or a position selected by a user.

The additional information synthesizing unit 2214 shifts the additional information by a first offset value in a first direction, and inserts the shifted additional information into the right-eye image. In addition, the additional information synthesizing unit 2214 shifts the additional information by the first offset value in a second direction opposite to the first direction, and inserts the shifted additional information into the left-eye image. Here, for example, the first offset value may be previously set, or may be set by a user.

The display unit 130 alternately or simultaneously displays the left-eye image and the right-eye image in order to display the 3D medical image.

The medical image reproducing apparatus 100b according to one or more exemplary embodiments may be implemented with any one or more of a PC, a tablet PC, a notebook computer, a smartphone, and/or the like. In another exemplary embodiment, the medical image reproducing apparatus 100b may include the image processor 62 and the output unit 64 of the MRI system. In this case, the reproduction unit 110b, the annotation inserting unit 120, and the additional information inserting unit 2210 may be implemented as the image processor 62, and the display unit 130 may be implemented as the output unit 64.

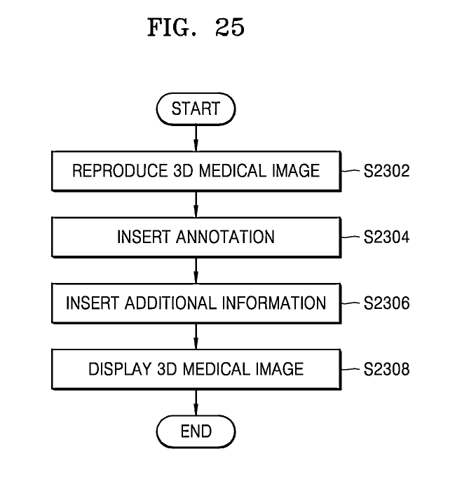

FIG. 25 is a flowchart of a medical image reproducing method, according to another exemplary embodiment.

In operation S2302, the 3D medical image reproducing method according to the present exemplary embodiment first decodes a file which includes a 3D medical image in order to obtain a left-eye image and right-eye image of a 3D series image which is to be reproduced, thereby generating the 3D medical image.

Subsequently, an annotation is inserted into each of the left-eye image and the right-eye image in operation S2304. A position of the annotation may be determined according to an offset value of the 3D series image which is to be reproduced, and the annotation may be inserted into each of the left-eye image and the right-eye image based on the determined position.

In operation S2306, additional information is inserted into each of the left-eye image and the right-eye image. Operation S2304 of inserting the annotation and operation S2306 of inserting the additional information may be switched in order. A position of the additional information in each of the left-eye image and right-eye images is determined according to the offset value of the 3D series image which is to be reproduced, and the additional information is thusly inserted into the left-eye image and the right-eye image.

Subsequently, by displaying the left-eye image and the right-eye image, the 3D medical image is displayed in operation 2308.

As described above, according to the one or more of the above-described exemplary embodiments, a user's eye fatigue may be reduced when providing an annotation in a 3D medical image.

Moreover, according to the one or more of the above-described exemplary embodiments, an annotation and additional information are three-dimensionally provided in a 3D medical image.

The exemplary embodiments may be written as computer programs and may be implemented in general-use digital computers that execute the programs using a transitory or non-transitory computer-readable recording medium.

Examples of the computer-readable recording medium include magnetic storage media (e.g., ROM, floppy disks, hard disks, etc.) and optical recording media (e.g., CD-ROMs or DVDs).

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present inventive concept as defined by the following claims.

What is claimed is:

1. A medical image reproducing method comprising:
reproducing a three-dimensional (3D) medical image which includes a left-eye image and a right-eye image;
determining a 3D effect of an annotation based on an offset value which relates to an offset between the left-eye image and the right-eye image;
inserting the annotation into the 3D medical image; and
displaying the annotated 3D medical image.

2. The medical image reproducing method of claim 1, wherein the inserting the annotation comprises:
determining a position of the annotation;
shifting the determined position of the annotation by the offset value in a first direction in order to insert the shifted annotation into the right-eye image; and
shifting the determined position of the annotation by the offset value in a second direction in order to insert the shifted annotation into the left-eye image, the second direction being opposite to the first direction.

3. The medical image reproducing method of claim 1, wherein the offset value is stored with the 3D medical image.

4. The medical image reproducing method of claim 1, wherein:
the 3D medical image comprises a plurality of 3D series images which are associated with different respective offset values, and
the reproducing the 3D medical image comprises reproducing at least one of the plurality of 3D series images.

5. The medical image reproducing method of claim 4, further comprising determining a 3D effect of additional information based on an offset value which relates to the reproduced at least one 3D series image, and inserting the additional information into the reproduced at least one 3D series image.

6. The medical image reproducing method of claim 5, wherein the inserting the additional information comprises:
determining a position of the additional information;
shifting the determined position of the additional information by the offset value which relates to the reproduced at least one 3D series image in a first direction in order to insert the shifted additional information into a right-eye image of the reproduced at least one 3D series image; and
shifting the determined position of the additional information by the offset value which relates to the reproduced at least one 3D series image in a second direction in order to insert the shifted additional information into a left-eye image of the reproduced at least one 3D series image, the second direction being opposite to the first direction.

7. The medical image reproducing method of claim 5, further comprising, when a first reproduced 3D series image is changed while reproducing the 3D medical image, reflecting an offset value which relates to the first reproduced 3D series image in order to insert the additional information into the first reproduced 3D series image.

8. The medical image reproducing method of claim 4, wherein the inserting the annotation comprises inserting an annotation, which is associated with the reproduced at least one 3D series image, into the reproduced at least one 3D series image based on an offset value which relates to the reproduced at least one 3D series image.

9. The medical image reproducing method of claim 1, wherein the inserting the annotation comprises, when a first object included in the 3D medical image is selected while reproducing the 3D medical image, inserting an annotation which is associated with the first object into the 3D medical image based on an offset value which corresponds to the first object.

10. A medical image reproducing apparatus comprising:
a reproduction device configured to reproduce a three-dimensional (3D) medical image which includes a left-eye image and a right-eye image;
an annotation inserter configured to determine a 3D effect of an annotation based on an offset value which relates to an offset between the left-eye image and the right-eye image, and to insert the annotation into the 3D medical image; and
a display device configured to display the annotated 3D medical image.

11. The medical image reproducing apparatus of claim 10, wherein the annotation inserter comprises:
an annotation position determiner configured to determine a position of the annotation; and
an annotation synthesizer configured to shift the determined position of the annotation by the offset value in a first direction in order to insert the shifted annotation into the right-eye image, and to shift the determined position of the annotation by the offset value in a second direction in order to insert the shifted annotation into the left-eye image, the second direction being opposite to the first direction.

12. The medical image reproducing apparatus of claim 10, wherein the offset value is stored with the 3D medical image.

13. The medical image reproducing apparatus of claim 10, wherein,
the 3D medical image comprises a plurality of 3D series images which are associated with different respective offset values, and
the reproduction device is further configured to reproduce the 3D medical image by reproducing at least one of the plurality of 3D series images.

14. The medical image reproducing apparatus of claim 13, further comprising an additional information inserter configured to determine a 3D effect of additional information based on an offset value which relates to the reproduced at least one 3D series image, and to insert the additional information into the reproduced at least one 3D series image.

15. The medical image reproducing apparatus of claim 14, wherein the additional information inserter comprises:
an additional information position determiner configured to determine a position of the additional information; and
an additional information synthesizer configured to shift the determined position of the additional information by the offset value which relates to the reproduced at least one 3D series image in a first direction in order to insert the shifted additional information into a right-eye image of the reproduced at least one 3D series image, and to shift the determined position of the additional information by the offset value which relates to the reproduced 3D series image in a second direction in order to insert the shifted additional information into a left-eye image of the reproduced at least one 3D series image, the second direction being opposite to the first direction.

16. The medical image reproducing apparatus of claim 14, wherein when a first reproduced 3D series image is changed while reproducing the 3D medical image, the additional information inserter is further configured to reflect an offset value which relates to the first reproduced 3D series image in order to insert the additional information into the first reproduced 3D series image.

17. The medical image reproducing apparatus of claim 13, wherein the annotation inserter is further configured to insert an annotation, which is associated with the reproduced at least one 3D series image, into the reproduced at least one 3D series image based on an offset value which relates to the reproduced at least one 3D series image.

18. The medical image reproducing apparatus of claim 10, wherein when a first object included in the 3D medical image is selected while reproducing the 3D medical image, the annotation inserter is further configured to insert an annotation associated with the first object into the 3D medical image based on an offset value which corresponds to the first object.

19. A non-transitory computer-readable storage medium storing a program which, when read and executed by a computer, performs a medical image reproducing method, the method comprising:
reproducing a three-dimensional (3D) medical image which includes a left-eye image and a right-eye image;
determining a 3D effect of an annotation based on an offset value which relates to an offset between the left-eye image and the right-eye image;
inserting the annotation into the 3D medical image; and
displaying the annotated 3D medical image.

20. The non-transitory computer-readable storage medium of claim 19, wherein the inserting the annotation comprises:
determining a position of the annotation;
shifting the determined position of the annotation by the offset value in a first direction in order to insert the shifted annotation into the right-eye image; and
shifting the determined position of the annotation by the offset value in a second direction in order to insert the shifted annotation into the left-eye image, the second direction being opposite to the first direction.

21. A method for displaying a medical image, comprising:
generating a three-dimensional (3D) medical image which includes a two-dimensional (2D) left-eye image and a 2D right-eye image;
determining a position of an annotation based on an offset value which relates to an offset between the left-eye image and the right-eye image;
inserting the annotation into the 3D medical image based on the determined position; and
displaying the annotated 3D medical image.

22. The method of claim 21, wherein the determining the position comprises determining a length of a horizontal shift with respect to a predetermined vertical axis position for each of the left-eye image and the right-eye image.

23. The method of claim 21, wherein:
the generating the 3D medical image comprises generating a plurality of 3D series images which are associated with different respective offset values, and
the method further comprises selecting at least one from among the plurality of 3D series images and performing the determining and inserting with respect to the selected at least one 3D series image.

24. The method of claim 23, further comprising determining a position of an additional information item with respect to the selected at least one 3D series image, and inserting the additional information into the selected at least one 3D series image based on the determined position of the additional information.

25. A medical image generating apparatus comprising:
an image generator configured to generate a three-dimensional (3D) medical image which includes a two-dimensional (2D) left-eye image and a 2D right-eye image;
an image analyzer configured to determine a position of an annotation based on an offset value which relates to an offset between the left-eye image and the right-eye image;
an image synthesizer configured to insert the annotation into the 3D medical image based on the determined position; and
a display configured to display the annotated 3D medical image.

26. The medical image generating apparatus of claim 25, wherein the image analyzer is further configured to determine a length of a horizontal shift with respect to a predetermined vertical axis position for each of the left-eye image and the right-eye image.

27. The medical image generating apparatus of claim 25, wherein:
the image generator is further configured to generate the 3D medical image by generating a plurality of 3D series images which are associated with different respective offset values, and
the image analyzer is further configured to select at least one from among the plurality of 3D series images and to determine the position of the annotation with respect to the selected at least one 3D series image.

28. The medical image generating apparatus of claim 27, wherein the image analyzer is further configured to determine a position of an additional information item with respect to the selected at least one 3D series image, and the image synthesizer is further configured to insert the additional information into the selected at least one 3D series image based on the determined position of the additional information.
